(19) United States
(12) Patent Application Publication
(10) Pub. No.: US 2006/0230909 A1
(43) Pub. Date: Oct. 19, 2006

(54) Operating method of a music composing device

(75) Inventors: Jung Min Song, Seoul (KR); Yong Chul Park, Seoul (KR); Jun Yup Lee, Gyeongi-do (KR); Yong Hee Lee, Seoul (KR)

Correspondence Address: LEE, HONG, DEGERMAN, KANG & SCHMADEKA, 801 S. FIGUEROA STREET, 12TH FLOOR, LOS ANGELES, CA, 90017, US

(73) Assignee: LG Electronics Inc.

(21) Appl. No.: 11/404,671

(22) Filed: Apr. 13, 2006

(30) Foreign Application Priority Data
Apr. 18, 2005 (KR) 10-2005-0032116

(51) Int. Cl. G10H 7/00; A63H 5/00; G04B 13/00

(52) U.S. Cl. 84/609

(57) ABSTRACT

A method for generating a music file includes receiving a melody from a user through a user interface, and generating a melody file corresponding to the received melody. The method further includes generating a harmony accompaniment file responsive to melody represented by the melody file, and generating a music file by synthesizing the melody file and the harmony accompaniment file.

### CROSS-REFERENCE TO RELATED APPLICATIONS

Pursuant to 35 U.S.C. § 119(a), this application claims the benefit of earlier filing date and right of priority to Korean Application No. 10-2005-0032116, filed on Apr. 18, 2005, the contents of which are hereby incorporated by reference herein in its entirety. This application is also related to U.S. patent application entitled “MUSIC COMPOSING DEVICE,” which was filed on the same date as the present application.

### BACKGROUND OF THE INVENTION

1. Field of the Invention

The present invention relates to a method of operating a music composing device.

2. Description of the Related Art

Music is based on three elements, commonly referred to as melody, harmony, and rhythm. Music changes with era, and is an integral part of life for many people. Melody is a basic factor of music. Melody is an element that represents musical expression and human emotion. Melody is a horizontal line connection of sounds having pitch and duration. Harmony is a concurrent (vertical) combination of multiple sounds, while melody is a horizontal or minor arrangement of sounds having different pitches. In order for such a sound sequence to have musical meaning, temporal order (that is, rhythm) has to be included.

People compose music by expressing their own emotions in melody, and a complete song is formed by combining lyrics with the melody. However, ordinary people who are not musical specialists have difficulty creating harmony and rhythm accompaniments suitable for the melody that they produce. Accordingly, there is a need for music composing devices that may automatically produce harmony and rhythm accompaniments suitable for a particular melody.

### SUMMARY OF THE INVENTION

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

In accordance with an embodiment of the present invention, a method for generating a music file includes receiving a melody from a user through a user interface, and generating a melody file corresponding to the received melody. The method further includes generating a harmony accompaniment file responsive to melody represented by the melody file, and generating a music file by synthesizing the melody file and the harmony accompaniment file.

In one aspect, the received melody represents humming by the user.

In another aspect, the method further includes generating the received melody responsive to a press and release, or other manipulation, of at least one button of a plurality of buttons associated with the user interface.

In yet another aspect, the method further includes displaying a score on a display, and generating the received melody responsive to user manipulation of at least one of a plurality of buttons individually corresponding to pitch or duration of a note.

In one aspect, the method further includes generating the harmony accompaniment file by selecting a chord corresponding to each bar constituting the melody represented by the melody file.

In accordance with one feature, the method further includes generating a rhythm accompaniment file corresponding to the melody represented by the melody file.

In another feature, the method further includes generating a second music file by synthesizing the melody file, the harmony accompaniment file, and the rhythm accompaniment file.

In another aspect, the method further includes storing in a storage unit at least one of the melody file, the harmony accompaniment file, the music file, and a previously composed music file.

In yet another aspect, the method further includes receiving and displaying a melody file that is stored in the storage unit, receiving an editing request from the user, and editing the displayed melody file.

In accordance with another embodiment of the present invention, a method for generating a music file includes receiving a melody from a user through a user interface, generating a melody file corresponding to the received melody, and detecting chord for each bar of melody represented by the melody file. The method may also include generating a harmony/rhythm accompaniment file corresponding to the received melody and based upon the detected chord, and generating a music file by synthesizing the melody file and the harmony/rhythm accompaniment file.

In another aspect, the method includes analyzing the received melody and generating dividing bars according to previously assigned beats, dividing sounds of the received melody into a predetermined number of notes and assigning weight values to each of the predetermined number of notes, determining major/minor mode of the received melody to generate key information, and mapping chords corresponding to the dividing bars based upon the key information and the weight values of each of the predetermined number of notes.

In one feature, the method includes selecting style of an accompaniment that is to be added to the received melody, changing a reference chord, according to a selected style, into the detected chord for each bar of melody represented by the melody file, sequentially linking the changed reference chords according to a musical instrument, and generating an accompaniment file comprising the linked reference chords.

In accordance with yet another embodiment, a method for operating a mobile terminal includes receiving a melody from a user through a user interface, generating a melody file corresponding to the received melody, generating a harmony accompaniment file responsive to melody represented by the melody file, and generating a music file by synthesizing the melody file and the harmony accompaniment file.

In another aspect, the method includes receiving a melody from a user through a user interface, generating a melody file corresponding to the received melody, detecting a chord for each bar of melody represented by the melody file, generating a harmony/rhythm accompaniment file corresponding to the received melody and based upon the detected chord, and generating a music file by synthesizing the melody file and the harmony/rhythm accompaniment file.

In another feature, the method includes analyzing the received melody and generating dividing bars according to previously assigned beats, dividing sounds of the received melody into a predetermined number of notes and assigning weight values to each of the predetermined number of notes, determining major/minor mode of the received melody to generate key information, and mapping chords corresponding to the dividing bars based upon the key information and the weight values of each of the predetermined number of notes.

In another aspect, the method includes selecting style of an accompaniment that is to be added to the received melody, changing a reference chord, according to a selected style, into the detected chord for each bar of melody represented by the melody file, sequentially linking the changed reference chords according to a musical instrument, and generating an accompaniment file comprising the linked reference chords.

In accordance with yet another embodiment, a method of operating a mobile communication terminal includes receiving a melody from a user through a user interface, generating a melody file corresponding to the received melody, generating a harmony accompaniment file responsive to melody represented by the melody file, generating a music file by synthesizing the melody file and the harmony accompaniment file, selecting the generated music file as a bell sound for the terminal, and playing the selected music file as the bell sound responsive to a call connecting to the terminal.

In one aspect, the accompaniment file is a file of MIDI format.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments. In the drawings:

FIG. 1 is a block diagram of a music composing device according to a first embodiment of the present invention;

FIG. 2 is diagram illustrating a case in which melody is inputted during a humming mode in a music composing device;

FIG. 3 is a diagram illustrating a case in which melody is inputted during a keyboard mode in a music composing device;

FIG. 4 is a diagram illustrating a case in which melody is inputted during a score mode in a music composing device;

FIG. 5 is a flowchart illustrating a method for operating a music composing device according to an embodiment of the present invention;

FIG. 6 is a block diagram of a music composing device according to a second embodiment of the present invention;

FIG. 7 is a block diagram of a chord detector of a music composing device;

FIG. 8 illustrates chord division in a music composing device;

FIG. 9 illustrates a case in which chords are set at the divided bars in a music composing device;

FIG. 10 is a block diagram of an accompaniment creator of a music composing device;

FIG. 11 is a flowchart illustrating a method for operating a music composing device;

FIG. 12 is a block diagram of a mobile terminal according to a third embodiment of the present invention;

FIG. 13 is a flowchart illustrating a method for operating a mobile terminal;

FIG. 14 is a block diagram of a mobile terminal according to a fourth embodiment of the present invention;

FIG. 15 is a flowchart illustrating a method for operating a mobile terminal according to an embodiment of the present invention;

FIG. 16 is a block diagram of a mobile communication terminal according to a fifth embodiment of the present invention;

FIG. 17 is a view of a data structure showing various types of data stored in a storage unit of a mobile communication terminal; and

FIG. 18 is a flowchart illustrating a method for operating a mobile communication terminal.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or similar parts.

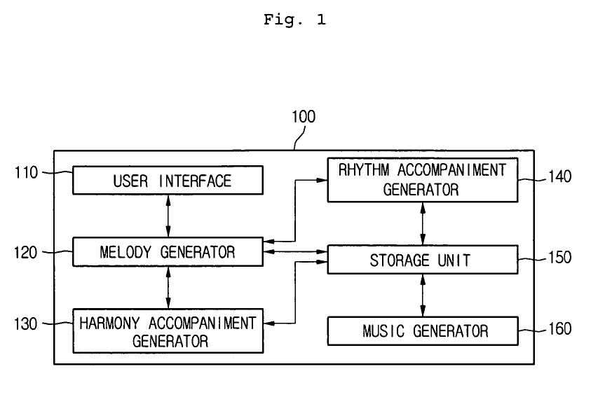

FIG. 1 is a block diagram of a music composing device according to a first embodiment of the present invention. Referring to FIG. 1, music composing device 100 includes user interface 110, melody generator 120, harmony accompaniment generator 130, rhythm accompaniment generator 140, storage unit 150, and music generator 160.

During operation, user interface 110 receives a melody from a user. This melody includes a horizontal line connection of sounds having pitch and duration. Melody generator 120 generates a melody file corresponding to the melody inputted through user interface 10. Harmony accompaniment generator 130 analyzes the melody file generated by melody generator 120, detects a harmony suitable for the melody, and then generates a harmony accompaniment file.

Rhythm accompaniment generator 140 analyzes the melody file, detects a rhythm suitable for the melody, and then generates a rhythm accompaniment file. Rhythm accompaniment generator 140 may recommend to the user a suitable rhythm style through melody analysis. Rhythm accompaniment generator 140 may also generate a rhythm accompaniment file according to the rhythm style requested from the user.

Music generator 160 synthesizes the melody file, the harmony accompaniment file, and the rhythm accompaniment file, and generates a music file. The various files and other data generated by music composing device 100 may be stored in storage unit 150.

Music composing device 100 according to an embodiment of the present invention receives only the melody from the user, synthesizes the harmony accompaniment and rhythm accompaniment suitable for the inputted melody, and then generates a music file. Accordingly, ordinary persons who are not musical specialists may easily create pleasing music.

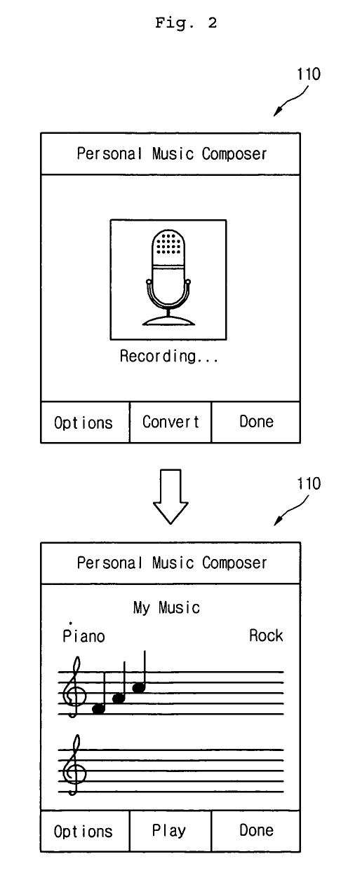

The melody may be received from the user in various ways, and user interface 110 may be modified accordingly. One method is to receive the melody in a humming mode. FIG. 2 illustrates the input of melody in the humming mode in a music composing device. In this embodiment, the user may input a self-composed melody to music composing device 100 by humming or singing into a microphone, for example.

User interface 110 may further include a display unit. In this example, the display may indicate that the music composing device is in the humming mode, as illustrated in FIG. 2. The display unit may also display a metronome so that the user can adjust an incoming melody's tempo by referring to the metronome.

After input of the melody is finished, the user may request confirmation of the inputted melody. User interface 110 may output the melody inputted by the user through a speaker. As illustrated in FIG. 2, the melody may be displayed on the display unit in the form of a score. The user may select notes to be edited in the score, and edit pitch and/or duration of the selected notes.

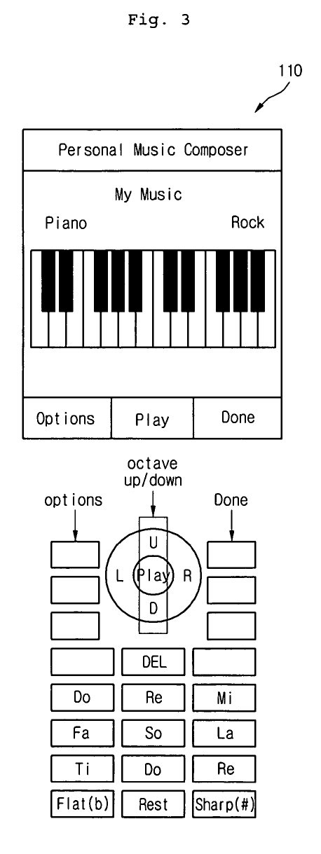

As another alternative, user interface 110 may be configured to receive the melody from the user during a keyboard mode. FIG. 3 illustrates such an embodiment of the present invention. As shown in this figure, user interface 110 may display a keyboard image on the display unit, and can be configured to receive the melody from the user by detecting a press/release of a button corresponding to a set note. As shown, scales (e.g., do, re, mi, fa, so, la, ti) are assigned to various buttons of the display unit. Therefore, pitch information may be obtained by detecting a particular button selected by the user. Also, duration information of the corresponding sound may be obtained by detecting how long a particular button is pressed. The user may also select octave by pressing an octave up/down button.

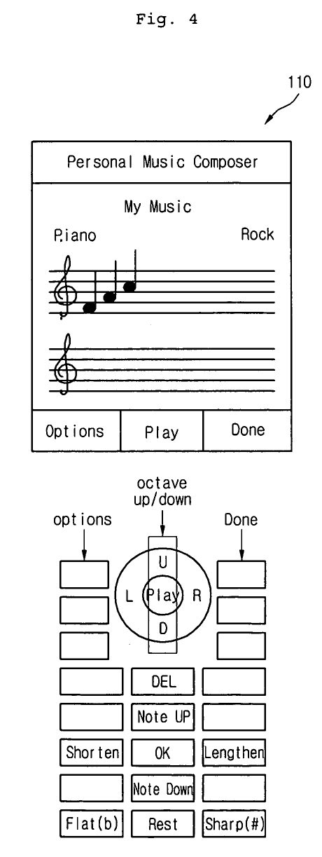

In accordance with an alternative embodiment, user interface 110 may receive the melody from the user during a score mode. FIG. 4 depicts such an embodiment. In this figure, user interface 110 displays the score on the display unit, and receives the melody through the user's manipulation of buttons associated with the display. For example, a note having a predetermined pitch and duration is displayed on the score. The user may increase the pitch by pressing a first button (Note UP), or decrease the pitch by pressing a second button (Note Down). The user may also lengthen the duration by pressing a third button (Lengthen) or shorten the duration by pressing a fourth button (Shorten). In this manner, the user may input the pitch and duration information of the sound. By repeating these various processes, the user may input a self-composed melody.

After completing input of the melody, the user may request confirmation of the inputted melody by displaying the melody on the display unit in the form of a score. The user may select notes to be edited in the score displayed on user interface 110, and edit pitch and/or duration of the selected notes.

Referring back to FIG. 1, harmony accompaniment generator 130 analyzes the basic melody for accompaniment with respect to the melody file generated by melody generator 120. A chord is selected based on analysis data corresponding to each bar that forms the melody. Here, the chord represents the setting at each bar for the harmony accompaniment, and is used for distinguishing these items from the overall harmony of the music.

For example, when playing a guitar while singing a song, chords set at each bar are played. A singing portion corresponds to a melody composition portion, and harmony accompaniment generator 130 functions to determine and select the chord suitable for the song at various moments.

The above description relates to the generation of the music file, and describes adding the harmony accompaniment and/or the rhythm accompaniment with respect to the melody provided through user interface 110. However, the received melody may include melody composed by the user in addition to an existing composed melody. For example, an existing melody stored in storage unit 150 may be retrieved, and a new melody may be composed by editing the retrieved melody.

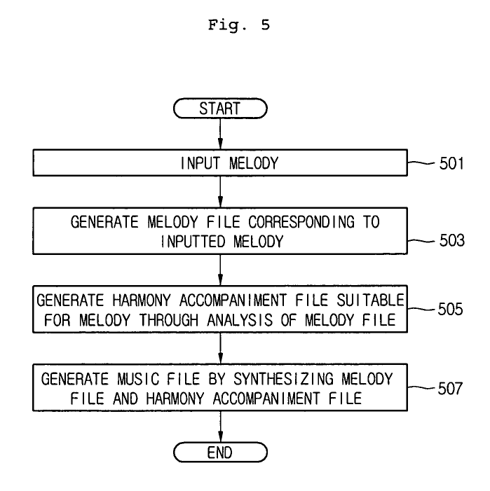

FIG. 5 is a flowchart illustrating a method for operating a music composing device according to an embodiment of the present invention. In operation 501, the melody is inputted. This operation may be accomplished by inputting the melody through user interface 110. The user may input the self-composed melody to the music composing device using any of the various techniques described herein. For example, the user may input the melody by humming, singing a song, using a keyboard, or using a score mode.

In operation 503, after the melody is inputted, melody generator 120 generates a melody file corresponding to the inputted melody.

In operation 505, harmony accompaniment generator 130 analyzes the melody file and generates a harmony accompaniment file suitable for the melody. In operation 507, music generator 160 generates a music file by synthesizing the melody file and the harmony accompaniment file.

Although operation 505 includes generating the harmony accompaniment file, the rhythm accompaniment file may also be generated through analysis of the melody file generated in operation 503. In this embodiment, operation 507 may then include generating the music file by synthesizing the melody file, the harmony accompaniment file, and the rhythm accompaniment file. The files and other data generated by the various operations depicted in FIG. 5 may be stored in storage unit 150.

The music composing device in accordance with an embodiment of the present invention receives a simple melody from the user, generates harmony and rhythm accompaniments suitable for the inputted melody, and then generates a music file by synthesizing these components. Accordingly, a benefit provided by this and other embodiments of the present invention is that ordinary people who are not musical specialists may easily create aesthetically pleasing music.

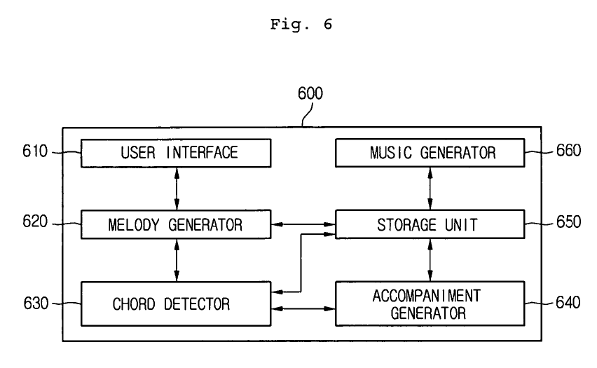

FIG. 6 is a block diagram of a music composing device according to a second embodiment of the present invention. This figure depicts music composing device 600 as including user interface 610, melody generator 620, chord detector 630, accompaniment generator 640, storage unit 650, and music generator 660.

User interface 610 and melody generator 620 operate in a manner similar to the user interface and melody generator described above. Chord detector 630 analyzes the melody file generated by the melody generator, and detects a chord suitable for the melody.

The accompaniment generator 640 generates the accompaniment file based upon the chord information detected by chord detector 630. The accompaniment file represents a file containing both the harmony accompaniment and the rhythm accompaniment. Music generator 660 synthesizes the melody file and the accompaniment file, and consequently generates a music file.

Music composing device 600 according to an embodiment of the present invention need only receive a melody from the user to generate a music file. This is accomplished by synthesizing the harmony accompaniment and rhythm accompaniment suitable for the inputted melody. The various files and other data generated by the components of music composing device 600 may be stored in storage unit 650.

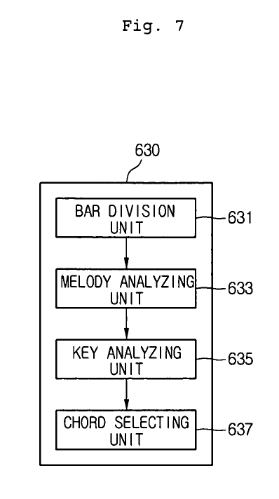

Similar to other embodiments, a melody may be received from the user using a variety of different techniques. For instance, the melody may be received from the user in a humming mode, a keyboard mode, and a score mode. Operation of chord detector 630 in detecting a chord suitable for the inputted melody will now be described with reference to FIGS. 7-9. This cord detecting process may be applied to a music composing device in accordance with an embodiment of the present invention.

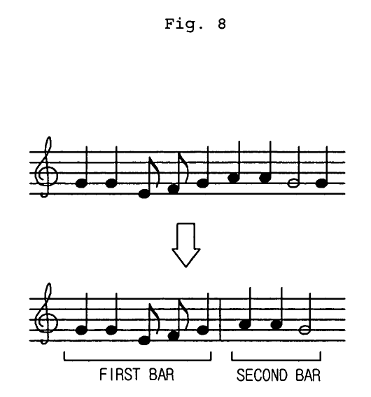

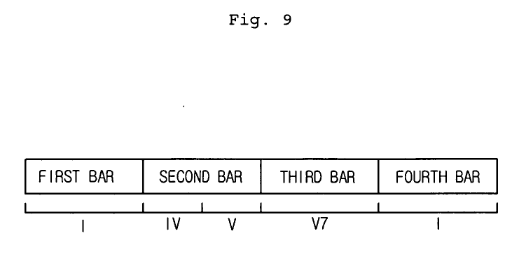

FIG. 7 is a block diagram of chord detector 630, FIG. 8 is an example of bar division, and FIG. 9 depicts an exemplary chord set to the divided bars. Referring to FIG. 7, chord detector 630 includes bar division unit 631, melody analyzing unit 633, key analyzing unit 635, and chord selecting unit 637.

Bar division unit 631 analyzes the inputted melody and divides the bars according to the previously assigned beats. For example, in the case of a 4/4 beat, the length of a note is calculated every 4 beats and is presented on a display depicting representative musical paper (FIG. 8). Notes that are overlapped over the bar are divided using a tie.

Melody analyzing unit 633 divides sounds into twelve notes, and assigns weight values to the lengths of the sound (one octave is divided into twelve notes, for example, and one octave in piano keys consists of twelve white keys and black keys in total). Increasing longer notes are assigned increasing greater weights. On the other hand, lower weight values are assigned to shorter notes. Therefore, relatively greater weight values are assigned to longer notes, in contrast to relatively lower weight values that are assigned to shorter notes. Also, strong/weak conditions suitable for the beats are considered. For example, a 4/4 beat has strong/weak/semi-strong/weak rhythms. In this case, higher weight values are assigned to the strong/semi-strong notes than other notes. In this manner, when selecting the chord, significant influence may be exercised.

Melody analyzing unit 633 assigns weight values, obtained by summing several conditions, to the respective notes. Therefore, when selecting the chord, the melody analyzing unit 633 provides melody analysis data to achieve the most harmonious accompaniment.

Key analyzing unit 635 determines, using the analysis data of the melody analyzing unit 633, the major/minor of the overall mode of the music. A key has C major, G major, D major, and A major according to the number of sharp (#). Another key has F major, Bb major, Eb major according to the number of flat (b). Since different chords are used in the respective keys, the above-described analysis is needed.

Chord selecting unit 637 maps chords that are most suitable for each bar by using key information obtained from key analyzing unit 635, and weight information obtained from melody analyzing unit 633. Chord selecting unit 637 may assign a chord to one bar according to the distribution of the notes, or it may assign the chord to a half bar. As illustrated in FIG. 9, chord I may be selected at the first bar, and chords IV and V may be selected at the second bar. Chord IV is selected at the first half-bar of the second bar, and chord V is selected at the second half-bar of the second bar. Using these processes, chord detector 630 may analyze the melody inputted from the user and detect the chord suitable for each bar.

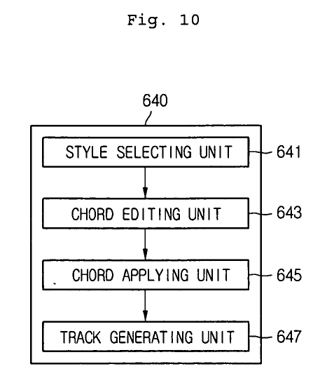

FIG. 10 is a block diagram of accompaniment generator 640, and includes style selecting unit 641, chord editing unit 643, chord applying unit 645, and track generating unit 647. Style selecting unit 641 selects a style of the accompaniment to be added to the melody inputted by the user. The accompaniment style may include hip-hop, dance, jazz, rock, ballade, and trot, among others. This accompaniment style may be selected by the user. Storage unit 650 may be used to store the chord files for the respective styles. Also, the chord files for the respective styles may be created according to various musical instruments. Typical musical instruments include a piano, a harmonica, a violin, a cello, a guitar, a drum, and the like. The chord files corresponding to the musical instruments are formed with a length of one bar, and are constructed with the basic chord I. It is apparent that the chord files for the various styles may be managed in a separate database, and may be constructed with other chords such as chords IV or V.

Chord editing unit 643 edits the chord, according to the selected style, and changes this chord into the chord of each bar that is actually detected by chord detector 630. For example, the hip-hop style selected by style selecting unit 641 consists of basic chord I. However, the bar selected by chord detector 630 may be matched with chords IV or V, not chord I. Therefore, chord editing unit 643 edits or otherwise changes the chord into a chord suitable for the actually detected bar. Also, chord editing is performed separately with respect to all musical instruments constituting the hip-hop style.

Chord applying unit 645 sequentially links the chords edited by chord editing unit 643, according to the musical instruments. For example, consider that hip-hop style is selected and the chord is selected as illustrated in FIG. 9. In this case, chord I of the hip-hop style is applied to the first bar, chord IV of the hip-hop style is applied to the first-half of the second bar, and chord V is applied to the second-half of the second bar. In this scenario, chord applying unit 645 sequentially links the chords of the hip-hop style, which are suitable for each bar. At this point, chord applying unit 645 sequentially links the chords according to the respective musical instruments. The chords are linked according to the number of the musical instruments. For example, the piano chord of the hip-hop style is applied and linked, and the drum chord of the hip-hop style is applied and linked.

Track generating unit 647 generates an accompaniment file that is created by linking the chords according to a musical instrument. The accompaniment files may be generated as independent musical instrument digital interface (MIDI) tracks.

Music generator 660 generates a music file by synthesizing the melody file and the accompaniment file. Music generator 660 may make one MIDI file by combining at least one MIDI file generated by track generating unit 647, and the melody tracks provided by the user.

The above description makes reference to a music file generated by adding an accompaniment to the inputted melody. As an alternative, after receiving the melody, a previously composed melody may be retrieved from storage unit 650. A new melody may then be composed by editing the retrieved melody.

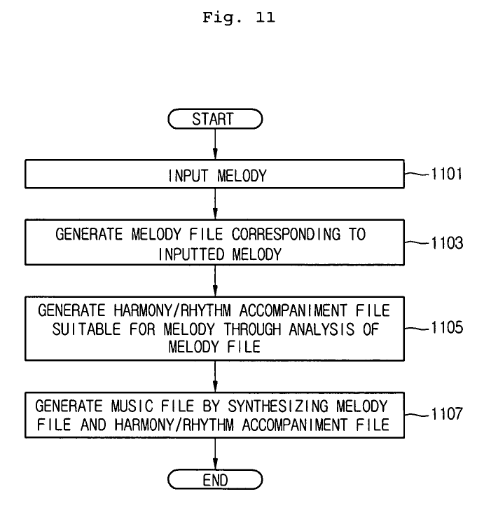

FIG. 11 is a flowchart illustrating a method for operating a music composing device according to an embodiment of the present invention, and will be described in conjunction with the music composing device of FIG. 6. As shown in FIG. 11, in operation 1101, the melody is inputted through user interface 610. The user may input the melody using any of the various techniques described herein. For example, the user may input the melody by humming, singing a song, using a keyboard, or using a score mode.

In operation 1103, after the melody is inputted through user interface 610, melody generator 620 generates a melody file corresponding to the inputted melody. In operation 1105, music composing device 600 analyzes the melody generated by melody generator 620, and generates a harmony/rhythm accompaniment file suitable for the melody. Chord detector 630 analyzes the melody file generated by melody generator 620, and detects the chord suitable for the melody.

Accompaniment generator 640 generates the accompaniment file by referring to the chord information detected by chord detector 630. The accompaniment file represents a file containing both the harmony accompaniment and the rhythm accompaniment. In operation 1107, music generator 660 synthesizes the melody file and the harmony/rhythm accompaniment file, and generates a music file. The various files and other data generated by the operations depicted in FIG. 11 may be stored in storage unit 650.

Music composing device 600 need only receive a melody from the user. Consequently, the music composing device generates the harmony/rhythm accompaniment suitable for the inputted melody, and generates the music file by synthesizing these items.

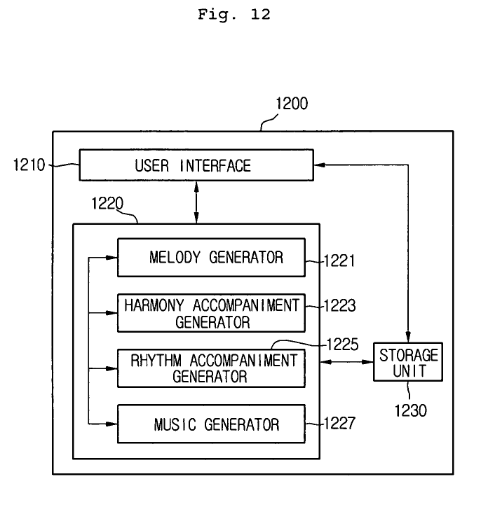

FIG. 12 is a block diagram of a mobile terminal according to a third embodiment of the present invention. Examples of a mobile terminal which may be configured in accordance with embodiments of the present invention include a personal data assistant (PDA), a digital camera, a mobile communication terminal, a camera phone, and the like.

Referring to FIG. 12, mobile terminal 1200 includes user interface 1210, music composition module 1220, and storage unit 1230. The music composition module includes melody generator 1221, harmony accompaniment generator 1223, rhythm accompaniment generator 1225, and music generator 1227.

User interface 1210 receives data, commands, and menu selections from the user, and provides audio and visual information to the user. In a manner similar to that previously described, the user interface is also configured to receive a melody from the user.

Music composition module 1220 generates harmony accompaniment and/or rhythm accompaniment corresponding to the melody inputted through user interface 1210. The music composition module 1220 generates a music file in which the harmony accompaniment and/or the rhythm accompaniment are added to the melody provided by the user.

Mobile terminal 1200 need only receive the melody from the user. Consequently, the mobile terminal generates the harmony accompaniment and the rhythm accompaniment suitable for the inputted melody, and provides the music file by synthesizing these items. The user may input the melody using any of the various techniques described herein (e.g., humming, singing a song, using a keyboard, or using a score mode). During operation, melody generator 1221 generates a melody file corresponding to the melody inputted through user interface 1210.

During operation, harmony accompaniment generator 1223 analyzes the melody file generated by melody generator 1221, detects a harmony suitable for the melody, and then generates a harmony accompaniment file.

Rhythm accompaniment generator 1225 analyzes the melody file generated by melody generator 1221, detects a rhythm suitable for the melody, and then generates a rhythm accompaniment file. The rhythm accompaniment generator may recommend to the user a suitable rhythm style through melody analysis. Also, the rhythm accompaniment generator may generate the rhythm accompaniment file according to a rhythm style requested by the user.

The music generator 1227 synthesizes the melody file, the harmony accompaniment file, and the rhythm accompaniment file, and then generates a music file.

The melody may be received from the user in various ways, and user interface 1210 may be modified accordingly. The various files and other data generated by the components of mobile terminal 1200 may be stored in storage unit 1230.

User interface 1210 may further include a display unit. In this configuration, a symbol that the humming mode is being performed may be displayed on the display unit. The display unit may also display a metronome, so that the user can adjust an incoming melody's tempo by referring to the metronome.

After melody input is finished, the user may request confirmation of the inputted melody. User interface 1210 may output the melody inputted by the user through a speaker. The melody may also be displayed on the display unit in the form of a score. The user may select notes to be edited in the displayed score, and modify pitch and/or duration of the selected notes.

Harmony accompaniment generator 1223 analyzes the basic melody for accompaniment with respect to the melody file generated by melody generator 1221. A chord is selected based on the analysis data corresponding to each bar that constructs the melody. Here, the chord represents the setting at each bar for the harmony accompaniment and is used for distinguishing from overall harmony of the music. For example, when playing the guitar while singing a song, chords set at each bar are played. A singing portion corresponds to a melody composition portion, and harmony accompaniment generator 1223 functions to determine and select the chord suitable for the song at each moment.

The above description relates to the generation of the music file, and describes adding the harmony accompaniment and/or the rhythm accompaniment with respect to the melody inputted through user interface 1210. However, the received melody may include melody composed by the user, in addition to an existing composed melody. For example, the existing melody stored in storage unit 1230 may be loaded, and a new melody may be composed by editing the loaded melody.

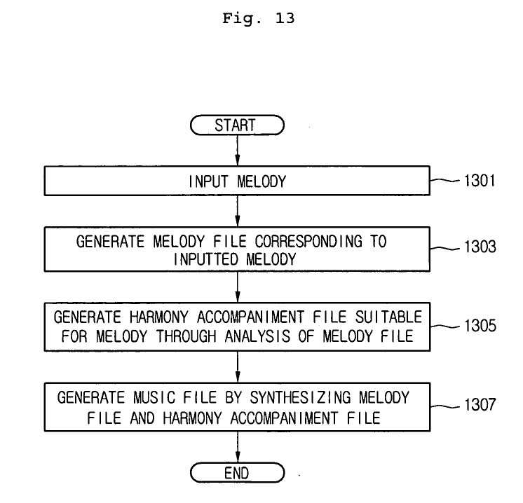

FIG. 13 is a flowchart illustrating a method for operating a mobile terminal according to a third embodiment of the present invention, and will be described in conjunction with the mobile terminal of FIG. 12. Referring to FIG. 13, in operation 1301, the melody is inputted through user interface 1210. The user may input the melody using any of the various techniques described herein (e.g., humming, singing a song, using a keyboard, or using a score mode).

In operation 1303, when the melody is inputted through user interface 1210, melody generator 1221 generates a melody file corresponding to the inputted melody. In operation 1305, harmony accompaniment generator 1223 of music composition module 1220 analyzes the melody file and generates a harmony accompaniment file suitable for the melody. In operation 1307, music generator 1227 synthesizes the melody file and the harmony accompaniment file, and generates a music file. The various files and other data generated by the operations depicted in FIG. 13 may be stored in storage unit 150.

Although operation 1305 includes generating a harmony accompaniment file, the rhythm accompaniment file may also be generated through the analysis of the melody file generated in operation 1303. In this embodiment, operation 1307 may then include generating the music file by synthesizing the melody file, the harmony accompaniment file, and the rhythm accompaniment file. Note that the various files and data generated at each operation depicted in FIG. 13 may be stored in storage unit 1230.

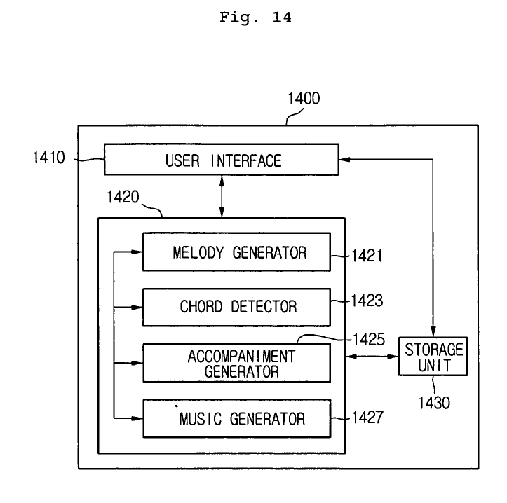

FIG. 14 is a block diagram of a mobile terminal according to a fourth embodiment of the present invention. Examples of a mobile terminal which may be configured in accordance with embodiments of the present invention include a personal data assistant (PDA), a digital camera, a mobile communication terminal, a camera phone, and the like.

Referring to FIG. 14, mobile terminal 1400 includes user interface 1410, music composition module 1420, and storage unit 1430. The music composition module includes melody generator 1421, chord detector 1423, accompaniment generator 1425, and music generator 1427. Similar to other user interfaces described herein, user interface 1410 receives data, command, and menu selections from the user, and provides audio information and visual information to the user.

Music composition module 1420 generates suitable harmony/rhythm accompaniment corresponding to the melody inputted through the user interface. The music composition module generates a music file in which the harmony/rhythm accompaniment is added to the melody inputted from the user.

Mobile terminal 1400 need only receive the melody from the user. Consequently, the mobile terminal generates the harmony accompaniment and the rhythm accompaniment suitable for the inputted melody, and provides the music file by synthesizing these items. The user may input the melody using any of the various techniques described herein (e.g., humming, singing a song, using a keyboard, or using a score mode).

Melody generator 1421 generates a melody file corresponding to the melody inputted through user interface 1410. Chord detector 1423 analyzes the melody file generated by melody generator 1421, and detects a chord suitable for the melody. Accompaniment generator 1425 generates the accompaniment file by referring to the chord information detected by chord detector 1423. The accompaniment file represents a file containing both the harmony accompaniment and the rhythm accompaniment.

Music generator 1427 synthesizes the melody file and the accompaniment file, and generates a music file. The various files and other data generated by the various components of mobile terminal 1400 may be stored in storage unit 1430. The user may input a melody using any of the various techniques described herein (e.g., humming, singing a song, using a keyboard, or using a score mode).

A process for detecting a chord suitable for the inputted melody in the chord detector 1423 will be described below. If desired, the process of detecting the chord may be implemented in mobile terminal 1200.

Chord detector 1423 analyzes the inputted melody, and divides the bars according to the previously assigned beats. For example, in the case of a 4/4 beat, length of a note is calculated every four beats and is drawn on a display representing music paper (see FIG. 8). Notes that overlap the bar are divided using a tie.

Chord detector 1423 divides sounds into twelve notes, and assigns weight values to the lengths of the sound (one octave is divided into twelve notes, for example, and one octave in piano keys consists of twelve white keys and black keys in total). Increasing longer notes are assigned increasing greater weights. On the other hand, lower weight values are assigned to shorter notes. Therefore, relatively greater weight values are assigned to longer notes, in contrast to relatively lower weight values that are assigned to shorter notes. Also, strong/weak conditions suitable for the beats are considered. For example, a 4/4 beat has strong/weak/semi-strong/weak rhythms. In this case, higher weight values are assigned to the strong/semi-strong notes than other notes. In this manner, when selecting the chord, significant influence may be exercised.

Chord detector 1423 assigns weight values, obtained by summing several conditions, to the respective notes. Therefore, when selecting the chord, chord detector 1423 provides the melody analysis data to provide for the most harmonious accompaniment.

The chord detector 1423 determines which major/minor the overall mode of the music has using the analysis data of the melody. A key has C major, G major, D major, and A major according to the number of sharp (#). A key has F major, Bb major, and Eb major according to the number of flat (b). Since different chords are used in the various keys, the above-described analysis is needed.

Chord detector 1423 maps the chords that are most suitable for each bar by using the analyzed key information and weight information. Chord detector 1423 may assign the chord to one bar according to the distribution of the notes, or may it assign the chord to a half bar. Through these processes, chord detector 1423 may analyze the melody inputted by the user and detect the chord suitable for each bar.

Accompaniment generator 1425 selects a style of the accompaniment to be added to the melody inputted by the user. The accompaniment style may include hip-hop, dance, jazz, rock, ballade, trot, and the like. The accompaniment style to be added to the inputted melody may be selected by the user. Storage unit 1430 may be used to store the chord files for the respective styles. The chord files for the respective styles may also be created according to a musical instrument. Examples of such musical instruments include piano, harmonica, violin, cello, guitar, and drum, among others. Chord files corresponding to musical instruments are formed with a length of one bar, and are constructed with the basic chord I. It is apparent that the chord files for the respective styles may be managed in a separate database, and may be constructed with other chords such as chords IV or V.

Accompaniment generator 1425 modifies chords according to the selected style of the chord of each bar that is actually detected by chord detector 1423. For example, a hip-hop style selected by accompaniment generator 1425 consists of the basic chord I. However, the bar selected by chord detector 1423 may be matched with chords IV or V, not chord I. Therefore, accompaniment generator 1425 modifies the chord into a new chord suitable for the actually detected bar. Also, this modification of chords is performed separately with respect to all musical instruments constituting the hip-hop style.

Accompaniment generator 1425 sequentially links the edited chords according to a musical instrument. For example, it is assumed that hip-hop style is selected and this chord is selected. In this case, chord I of the hip-hop style is applied to the first bar, chord IV of the hip-hop style is applied to the first-half of the second bar, and chord V is applied to the second-half the second bar. As such, accompaniment generator 1425 sequentially links the chords of the hip-hop style, which are suitable for each bar. At this point, accompaniment generator 1425 sequentially links the chords according to the particular musical instrument. For example, the piano chord of the hip-hop style is applied and linked, and the drum chord of the hip-hop style is applied and linked.

Accompaniment generator 1425 generates an accompaniment file having independent MIDI tracks that are produced by linking the chords according to musical instrument.

Music generator 1427 generates a music file by synthesizing the melody file and the accompaniment file, which are stored in storage unit 1430. Music generator 1427 may make one MIDI file by combining at least one MIDI file generated by accompaniment generator 1425, and the melody tracks inputted from the user.

The above description refers to generating a music file by adding the accompaniment to the inputted melody. However, the received melody may include the inputted melody, as well as an existing and previously composed melody. For example, the existing melody stored in storage unit 1430 may be loaded, and a new melody may be composed by editing the loaded melody.

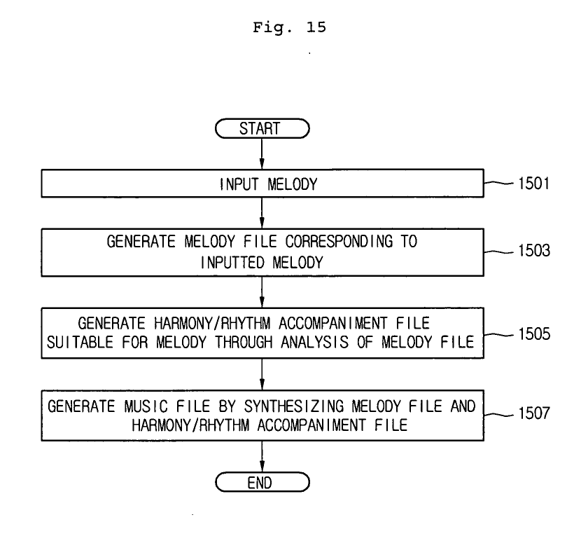

FIG. 15 is a flowchart illustrating a method for operating the mobile terminal according to an embodiment of the present invention, and will be described with reference to the mobile terminal of FIG. 14. Referring to FIG. 15, in operation 1501, the melody is inputted through user interface 1410. The user may input the melody using any of the various techniques described herein (e.g., humming, singing a song, using a keyboard, or using a score mode). In operation 1503, after the melody is inputted, melody generator 1421 generates a melody file corresponding to the inputted melody. In operation 1505, music composition module 1420 analyzes the melody generated by melody generator 1421, and generates the harmony/rhythm accompaniment file suitable for the melody.

Chord detector 1423 analyzes the melody file generated by melody generator 1421, and detects the chord suitable for the melody.

Accompaniment generator 1425 generates the accompaniment file by referring to the chord information detected by chord detector 1423. The accompaniment file represents a file containing both the harmony accompaniment and the rhythm accompaniment.

In operation 1507, music generator 1427 synthesizes the melody file, and the harmony/rhythm accompaniment file, and generates a music file. The files and other data generated by the various components of mobile terminal 1400 may be stored in storage unit 1430.

Mobile terminal 1400 in accordance with an embodiment of the present invention receives a simple melody from the user, generates harmony and rhythm accompaniments suitable for the inputted melody, and then generates a music file by synthesizing these components.

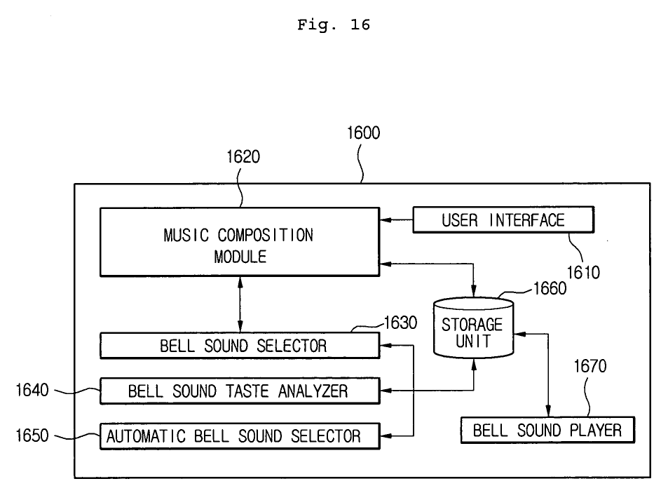

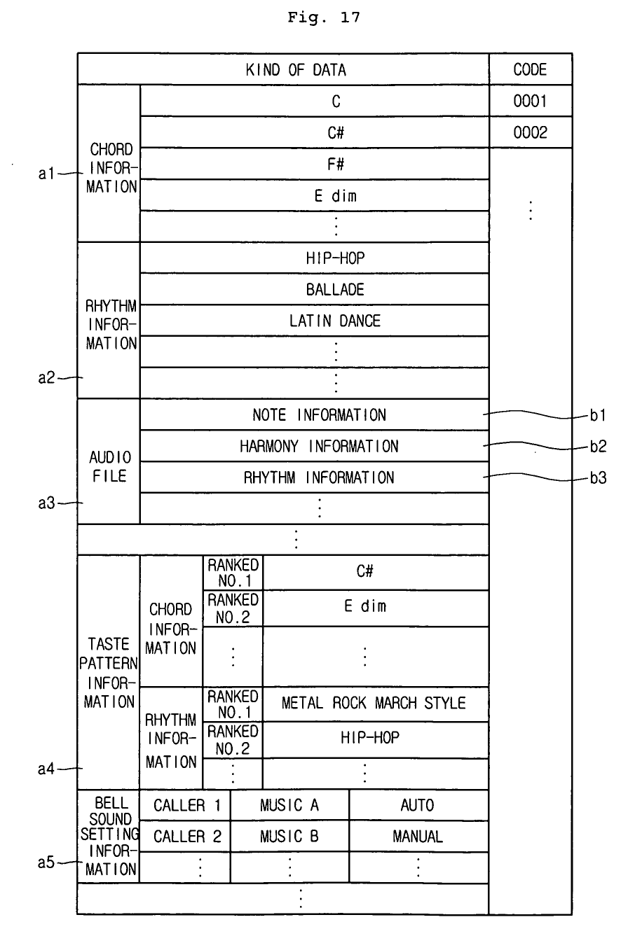

FIG. 16 is a block diagram of a mobile communication terminal according to a fifth embodiment of the present invention. FIG. 17 is a view of a data structure showing various types of data which can be stored in the storage unit of a mobile communication terminal.

Referring to FIG. 16, mobile communication terminal 1600 includes user interface 1610, music composition module 1620, bell sound selector 1630, bell sound taste analyzer 1640, automatic bell sound selector 1650, storage unit 1660, and bell sound player 1670.

User interface 1610 receives data, command, and menu selections from the user, and provides audio and visual information to the user. In a manner similar to that previously described, the user interface is also configured to receive a melody from the user.

Music composition module 1620 generates harmony accompaniment and rhythm accompaniment suitable for the inputted melody. Music composition module 1620 generates a music file in which the harmony accompaniment and rhythm accompaniment is added to the melody inputted from the user. If desired, music composition module 1620 may be implemented in mobile terminal 1200 as an alternative to music composition module 1220, or in mobile terminal 1400 as an alternative to music composition module 1420.

Mobile terminal 1600 need only receive a melody from the user. Consequently, the mobile terminal generates the harmony accompaniment and the rhythm accompaniment suitable for the inputted melody, and provides the music file by synthesizing these items. The user may input the melody using any of the various techniques described herein (e.g., humming, singing a song, using a keyboard, or using a score mode). The user may also transmit the self-composed music file to others. In addition, the music file may be used as the bell sound of mobile communication terminal 1600. Storage unit 1660 stores chord information a1, rhythm information a2, audio file a3, taste pattern information a4, and bell sound setting information a5.

Referring next to FIG. 17, several different types of information are depicted. First, chord information a1 represents harmony information applied to notes of the melody based on an interval theory (that is, the difference between two or more notes). Accordingly, even though the simple melody line is inputted through user interface 1610, the accompaniment may be implemented in a predetermined playing unit (e.g., musical piece based on beats) according to harmony information a1.

Second, rhythm information a2 is compass information related to the playing of a percussion instrument, such as a drum, or a rhythm instrument, such as a base. Rhythm information a2 basically consists of beat and accent, and includes harmony information and various rhythms based on beat patterns. According to rhythm information a2, various rhythm accompaniments such as ballade, hip-hop, and Latin dance may be implemented based on a predetermined replay unit (e.g., sentence) of the note.

Third, audio file a3 is a music playing file and may include a MIDI file. MIDI is a standard protocol for communication between electronic musical instruments for transmission/reception of digital signals. The MIDI file includes information such as timbre, pitch, scale, note, beat, rhythm, and reverberation.

Timbre information is associated with diapason and represents inherent properties of the sound. For example, timbre information changes with the kinds of musical instruments (sounds). Scale information represents pitch of the sound (generally seven scales, which are divided into major scale, minor scale, chromatic scale, and gamut). Note information b1 is a minimum unit of a musical piece. That is, note information b1 may act as a unit of a sound source sample. Also, music may be subtly performed using the beat information and reverberation information.

Each item of information of the MIDI file is stored as audio tracks. In this embodiment, note audio track b1, harmony audio track b2, and rhythm audio track b3 are used as the automatic accompaniment function.

Fourth, taste pattern information a4 represents ranking information of the most preferred (most frequently selected) chord information and rhythm information through analysis of the audio file selected by the user. Thus, according to the taste pattern information a4, audio file a3 preferred by the user may be selected based on the chord ranking information and the rhythm information.

Fifth, bell sound setting information a5 is information which is used to set the bell sound. The user can select audio file a3 as bell sound setting information a5, or this audio file can be automatically selected by analysis of the user's taste (which will be described below).

When the user presses a predetermined key button of a keypad provided at user interface 1610, a corresponding key input signal is generated and transmitted to music composition module 1620. Music composition module 1620 generates note information containing pitch and duration according to the key input signal, and constructs the generated note information in the note audio track.

At this point, music composing module 1620 maps predetermined pitch of the sound according to particular key buttons, and sets predetermined duration of the sound according to the duration that the key buttons are operated. Consequently, note information is generated. By operating a predetermined key together with the key buttons to which the notes are assigned, the user may input sharp (#) or flat (b). Therefore, music composition module 1620 generates note information to increase or decrease the mapped pitch by semitone.

In this manner, the user inputs a basic melody line by varying the time for which a key button is operated, and varying key button selection. At this point, user interface 1610 generates display information using musical symbols in real time, and displays these symbols on the display unit. The user may easily compose the melody line while checking the notes displayed on the musical paper representation in each bar.

Also, music composition module 1620 sets two operating modes; namely, a melody input mode and a melody confirmation mode. Each of these modes are user selectable. As described above, the melody input mode is for receiving note information, and the melody confirmation mode is for playing the melody so that the user may confirm the note information while composing the music. That is, if the melody confirmation mode is selected, music composition module 1620 plays the melody based on the cumulative note information which has been generated.

If an input signal of a predetermined key button is transmitted while melody input mode is active, music composition module 1620 plays a corresponding sound according to the scale assigned to the key button. Therefore, the user may confirm the notes displayed on the representative music paper, and may compose music while listening to the inputted sound or while playing all of the inputted sounds.

As described above, the user may compose original music using music composition module 1620. The user may also have composed and arranged the music using existing music and audio files. In this case, by the user's selection, music composition module 1620 may read another audio file stored in storage unit 1660.

Music composition module 1620 detects the note audio track of the selected audio file, and user interface 1610 displays the musical symbols. After reviewing this information, the user manipulates the keypad of user interface 1610. If a key input signal is received, the corresponding note information is generated, and the note information of the audio track is edited. When note information (melody) is inputted, music composition module 1620 provides an automatic accompaniment function suitable for the inputted note information (melody).

Music composition module 1620 analyzes the inputted note information in a predetermined unit, detects the applicable harmony information from storage unit 1660, and constructs the harmony audio track using the detected harmony information. The detected harmony information may be combined in a variety of different manners. Music composition module 1620 constructs a plurality of harmony audio tracks according to various types of harmony information and differences between such combinations.

Music composition module 1620 analyzes beats of the generated note information, detects the applicable rhythm information from storage unit 1660, and then constructs a rhythm audio track using the detected rhythm information. Music composition module 1620 constructs a plurality of rhythm audio tracks according to various types of rhythm information, and differences between such combinations.

Music composition module 1620 generates an audio file by mixing the note audio track, the harmony audio track, and the rhythm audio track. Since there is a plurality of tracks, a plurality of audio files may be generated and used for the bell sound.

If the user inputs the melody line via user interface 1610 using the above-described procedures, mobile communication terminal 1600 automatically generates the harmony accompaniment and rhythm accompaniment, and consequently generates a plurality of audio files.

Bell sound selector 1630 may provide the identification of an audio file to the user. If the user selects the audio file to be used as the bell sound, using user interface 1610, bell sound selector 1630 sets the selected audio file to be used as the bell sound (bell sound setting information).

The user repeatedly uses the bell sound setting function to generate bell sound setting information, which is stored in storage unit 1660. Bell sound taste analyzer 1640 analyzes the harmony information and rhythm information of the selected audio file, and generates information relating to the user's taste pattern.

Automatic bell sound selector 1650 selects a predetermined number of audio files to be used as the bell sound. This selection is made from a plurality of audio files composed or arranged by the user according to taste pattern information.

When a communication channel is connected and a ringer sound played, the corresponding audio file is parsed to generate playing information of the MIDI file, and playing information is arranged according to time sequence. Bell sound player 1670 sequentially reads the corresponding sound sources according to the playing time of each track, and converts their frequencies. The frequency-converted sound sources are outputted as the bell sound through the speaker of interface unit 1610.

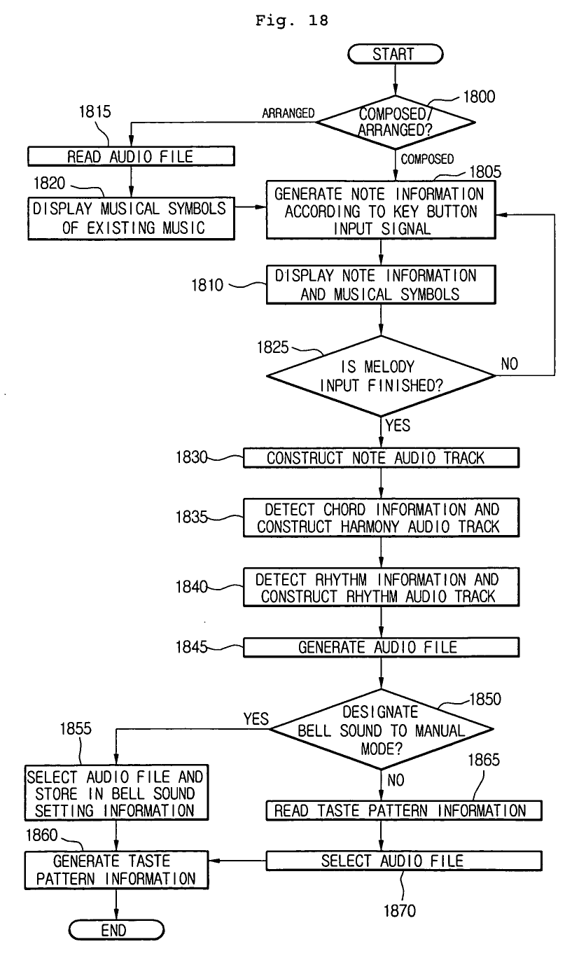

FIG. 18 is a flowchart illustrating a method for operating a mobile communication terminal according to an embodiment of the present invention, and will be described in conjunction with the mobile communication terminal of FIG. 16. Referring to FIG. 18, in operation 1800, it is determined whether to compose new music (e.g., a bell sound) or arrange existing music.

If a new music composition is selected, processing flows to operation 1805. In this operation, note information containing pitch and duration is generated using, for example, the input signal of a key button. On the other hand, if an arranged musical composition is selected, processing flows to operations 1815 and 1820. During these operations, music composition module 1620 reads the selected audio file, analyzes the note audio track, and then displays the musical symbols.

The user selects the notes of the existing music, and inputs scales for the selected notes by manipulating the keypad. In operations 1805 and 1810, music composition module 1620 maps the note information corresponding to the key input signal, and displays the mapped note information in an edited musical symbol format.

If the melody input is not finished, then processing flows back to operation 1805 and the just-described process is repeated. On the other hand, if melody input is completed, then processing flows to operation 1830, during which music composition module 1620 constructs the note audio track using the generated note information.

In operation 1835, after the note audio track is constructed, music composition module 1620 analyzes the generated note information in a predetermined unit, and detects the applicable chord information which is available from storage unit 1660. Next, according to the order of the note information, music composition module 1620 constructs the harmony audio track using the detected chord information.

In operation 1840, music composition module 1620 analyzes the beats contained in the note information of the note audio track, and detects the applicable rhythm information, which is available from storage unit 1660. Music composition module 1620 also constructs, according to the order of the note information, the rhythm audio track using the detected rhythm information.

In operation 1845, after the melody (the note audio track) is composed and arranged, and the harmony accompaniment (the harmony audio track) and the rhythm accompaniment (the rhythm audio track) are automatically generated, music composition module 1620 mixes the tracks to generate a plurality of audio files.

If the bell sound is manually designated, as provided in operation 1850, then processing flows to operation 1855. In this operation, bell sound selector 1630 provides identification of the bell sound, selects the audio file, and then stores the bell sound setting information in the corresponding audio file.

In operation 1860, bell sound taste analyzer 1640 analyzes the harmony information and rhythm information of the audio file of the bell sound, provides information on the user's taste pattern, and stores the taste pattern information in storage unit 1660.

Referring back to operation 1850, if the bell sound is not manually designated, then processing flows to operation 1865. In this operation, taste pattern information is read.

In operation 1870, automatic bell sound selector 1650 analyzes the composed or arranged audio file, or the stored audio files. The automatic bell sound selector then matches these audio files with taste pattern information (obtained in operation 1865), and selects the audio file to be used as the bell sound.

In operation 1860, when the bell sound is automatically designated, bell sound taste analyzer 1640 automatically analyzes the harmony information and the rhythm information, generates information on the user's taste pattern information, and stores it in storage unit 1660.

In a mobile communication terminal that may compose and arrange the bell sound according to an embodiment of the present invention, various harmony accompaniments and rhythm accompaniments are generated by inputting the desired melody through simple manipulation of the keypad, or by arranging existing music melodies. Pleasing bell sound contents may be obtained by mixing the accompaniments into one music file.

The user's preference of a bell sound may be searched based on music theory. Such a search may include the database of harmony information and rhythm information. The bell sound contents could therefore include newly composed/arranged bell sounds, or existing bell sounds. Automatically selecting the bell sound therefore eliminates the inconvenience of having to manually designate the bell sound. Nevertheless, manual selection of the bell sound is possible whenever a user has time available to make such a selection, or for those who enjoy composing or arranging music through a simple interface.

It will be apparent to those skilled in the art that various modifications and variations may be made in the present invention. Thus, it is intended that the present invention covers the modifications and variations of this invention provided they come within the scope of the appended claims and their equivalent.

What is claimed is:

1. A method for generating a music file, the method comprising:
receiving a melody from a user through a user interface;
generating a melody file corresponding to the received melody;
generating a harmony accompaniment file responsive to melody represented by the melody file; and
generating a music file by synthesizing the melody file and the harmony accompaniment file.

2. The method according to claim 1, wherein the received melody represents humming by the user.

3. The method according to claim 1, further comprising:
generating the received melody responsive to manipulation of at least one button of a plurality of buttons associated with the user interface.

4. The method according to claim 1, further comprising:
displaying a score on a display; and
generating the received melody responsive to user manipulation of at least one of a plurality of buttons individually corresponding to pitch or duration of a note.

5. The method according to claim 1, further comprising:
generating the harmony accompaniment file by selecting a chord corresponding to each bar constituting the melody represented by the melody file.

6. The method according to claim 1, further comprising:
generating a rhythm accompaniment file corresponding to the melody represented by the melody file.

7. The method according to claim 6, further comprising:
generating a second music file by synthesizing the melody file, the harmony accompaniment file, and the rhythm accompaniment file.

8. The method according to claim 1, further comprising:
storing in a storage unit at least one of the melody file, the harmony accompaniment file, the music file, and a previously composed music file.

9. The method according to claim 8, further comprising:
receiving and displaying a melody file that is stored in the storage unit;
receiving an editing request from the user; and
editing the displayed melody file.

10. A method for generating a music file, the method comprising:
receiving a melody from a user through a user interface;
generating a melody file corresponding to the received melody;
detecting chord for each bar of melody represented by the melody file;
generating a harmony/rhythm accompaniment file corresponding to the received melody and based upon the detected chord; and
generating a music file by synthesizing the melody file and the harmony/rhythm accompaniment file.

11. The method according to claim 10, wherein the received melody represents humming by the user.

12. The method according to claim 10, further comprising:
generating the received melody responsive to manipulation of at least one button of a plurality of buttons associated with the user interface.

13. The method according to claim 10, further comprising:
displaying a score on a display; and
generating the received melody responsive to user manipulation of at least one of a plurality of buttons individually corresponding to pitch or duration of a note.

14. The method according to claim 10, further comprising:
analyzing the received melody and generating dividing bars according to previously assigned beats;
dividing sounds of the received melody into a predetermined number of notes and assigning weight values to each of the predetermined number of notes;
determining major/minor mode of the received melody to generate key information; and
mapping chords corresponding to the dividing bars based upon the key information and the weight values of each of the predetermined number of notes.

15. The method according to claim 10, further comprising:
selecting style of an accompaniment that is to be added to the received melody;
changing a reference chord, according to a selected style, into the detected chord for each bar of melody represented by the melody file;
sequentially linking the changed reference chords according to a musical instrument; and
generating an accompaniment file comprising the linked reference chords.

16. The method according to claim 10, further comprising:
storing in a storage unit at least one of the melody file, the chord for each bar of melody, the harmony/rhythm accompaniment file, the music file, and a previously composed music file.

17. The method according to claim 16, further comprising:
receiving and displaying a melody file that is stored in the storage unit;
receiving an editing request from the user; and
editing the displayed melody file.

18. A method for operating a mobile terminal, the method comprising:
receiving a melody from a user through a user interface;
generating a melody file corresponding to the received melody;
generating a harmony accompaniment file responsive to melody represented by the melody file; and
generating a music file by synthesizing the melody file and the harmony accompaniment file.

19. The method according to claim 18, wherein the received melody represents humming by a user.

20. The method according to claim 18, further comprising:
generating the received melody responsive to manipulation of at least one button of a plurality of buttons associated with the user interface.

21. The method according to claim 18, further comprising:
displaying a score on a display; and
generating the received melody responsive to user manipulation of at least one of a plurality of buttons individually corresponding to pitch or duration of a note.

22. The method according to claim 18, wherein the generating of the harmony accompaniment file comprises:
selecting a chord corresponding to each bar constituting the melody represented by the melody file.

23. The method according to claim 18, further comprising:
generating a rhythm accompaniment file corresponding to the melody represented by the melody file.

24. The method according to claim 23, further comprising:
generating a second music file by synthesizing the melody file, the harmony accompaniment file, and the rhythm accompaniment file.

25. The method according to claim 18, further comprising:
storing in a storage unit at least one of the melody file, the harmony accompaniment file, the music file, and a previously composed music file.

26. The method according to claim 25, further comprising:
receiving and displaying a melody file that is stored in the storage unit;
receiving an editing request from the user; and
editing the displayed melody file.

27. A method of operating a mobile terminal, the method comprising:
receiving a melody from a user through a user interface;
generating a melody file corresponding to the received melody;
detecting a chord for each bar of melody represented by the melody file,
generating a harmony/rhythm accompaniment file corresponding to the received melody and based upon the detected chord; and
generating a music file by synthesizing the melody file and the harmony/rhythm accompaniment file.

28. The method according to claim 27, wherein the received melody represents humming by the user.

29. The method according to claim 27, further comprising:
generating the received melody responsive to manipulation of at least one button of a plurality of buttons associated with the user interface.

30. The method according to claim 27, further comprising:
displaying a score on a display; and
generating the received melody responsive to user manipulation of at least one of a plurality of buttons individually corresponding to pitch or duration of a note.

31. The method according to claim 27, further comprising:
analyzing the received melody and generating dividing bars according to previously assigned beats;
dividing sounds of the received melody into a predetermined number of notes and assigning weight values to each of the predetermined number of notes;
determining major/minor mode of the received melody to generate key information; and
mapping chords corresponding to the dividing bars based upon the key information and the weight values of each of the predetermined number of notes.

32. The method according to claim 27, further comprising:
selecting style of an accompaniment that is to be added to the received melody;
changing a reference chord, according to a selected style, into the detected chord for each bar of melody represented by the melody file;
sequentially linking the changed reference chords according to a musical instrument; and
generating an accompaniment file comprising the linked reference chords.

33. The method according to claim 27, further comprising:
storing in a storage unit at least one of the melody file, the chord for each bar of melody, the harmony/rhythm accompaniment file, the music file, and a previously composed music file.

34. The method according to claim 33, further comprising:
receiving and displaying a melody file that is stored in the storage unit;
receiving an editing request from the user; and
editing the displayed melody file.

35. A method of operating a mobile communication terminal, the method comprising:
receiving a melody from a user through a user interface;
generating a melody file corresponding to the received melody;
generating a harmony accompaniment file responsive to melody represented by the melody file;
generating a music file by synthesizing the melody file and the harmony accompaniment file;
selecting the generated music file as a bell sound for the terminal; and
playing the selected music file as the bell sound responsive to a call connecting to the terminal.

36. The method according to claim 35, wherein the received melody represents humming by the user.

37. The method according to claim 35, further comprising:
generating the received melody responsive to manipulation of at least one button of a plurality of buttons associated with the user interface.

38. The method according to claim 35, further comprising:
displaying a score on a display; and
generating the received melody responsive to user manipulation of at least one of a plurality of buttons individually corresponding to pitch or duration of a note.

39. The method according to claim 35, further comprising:
generating the harmony accompaniment file by selecting a chord corresponding to each bar constituting the melody represented by the melody file.

40. The method according to claim 35, further comprising:
generating a rhythm accompaniment file corresponding to the melody represented by the melody file.

41. The method according to claim 40, further comprising:
generating a second music file by synthesizing the melody file, the harmony accompaniment file, and the rhythm accompaniment file.

42. The method according to claim 35, further comprising:
storing in a storage unit at least one of the melody file, the harmony accompaniment file, the music file, and a previously composed music file.

43. The method according to claim 42, further comprising:
receiving and displaying a melody file that is stored in the storage unit;
receiving an editing request from the user, and
editing the displayed melody file.

44. The method according to claim 35, further comprising:
analyzing the received melody and generating dividing bars according to previously assigned beats;
dividing sounds of the received melody into a predetermined number of notes and assigning weight values to each of the predetermined number of notes;
determining major/minor mode of the received melody to generate key information; and
mapping chords corresponding to the dividing bars based upon the key information and the weight values of each of the predetermined number of notes.

45. The method according to claim 35, further comprising:
detecting chord for each bar of melody represented by the melody file;
selecting style of an accompaniment that is to be added to the received melody;
changing a reference chord, according to a selected style, into the detected chord for each bar of melody represented by the melody file;
sequentially linking the changed reference chords according to a musical instrument; and
generating an accompaniment file comprising the linked reference chords.

46. The method according to claim 45, wherein the accompaniment file is a file of MIDI format.
